(19) United States
(12) Patent Application Publication
(10) Pub. No.: US 2014/0352883 A1
(43) Pub. Date: Dec. 4, 2014

(54) ADHESIVE COMPOSITION FOR OPTICAL DEVICE AND ADHERING METHOD USING THE SAME

(71) Applicant: SAMSUNG ELECTRO-MECHANICS CO., LTD., Suwon (KR)

(72) Inventors: Jong Sik Kim, Suwon (KR); Yoon Min Lee, Suwon (KR); Dae Jun Kim, Suwon (KR)

(21) Appl. No.: 13/941,016

(22) Filed: Jul. 12, 2013

(30) Foreign Application Priority Data
May 28, 2013 (KR) 10-2013-0060543

(51) Int. Cl. C09J 133/14; B32B 37/16; B32B 38/00; B32B 37/12

(52) U.S. Cl. CPC C09J 133/14; B32B 37/12; B32B 37/16; B32B 38/0036; C08K 3/08
USPC 156/275.5; 522/81

(57) ABSTRACT

This invention relates to an adhesive composition for an optical device, including pigment balls having a core-shell structure, a thermocurable monomer or oligomer, a photocurable monomer or oligomer, a photoinitiator and a thermal initiator, and to a method of adhering an optical device using the adhesive composition. The adhesive for an optical device according to this invention can improve light shielding and photocuring properties.

### CROSS-REFERENCE TO RELATED APPLICATION

This application claims the benefit of Korean Patent Application No. 10˜2013˜0060543, filed May 28, 2013, entitled “Adhesive composition for optical devices and adhesive method using the same,” which is hereby incorporated by reference in its entirety into this application.

### BACKGROUND OF THE INVENTION

1. Technical Field

The present invention relates to an adhesive composition for an optical device and an adhering method using the same.

2. Description of the Related Art

In order to conventionally attach electronic parts such as chip resistors, condensers, etc. to printed circuit boards, the use of a hybrid composition comprising a photocurable resin and a thermocurable resin as an adhesive has been known. As the case where only a photocurable adhesive is used incurs problems in which the reaction rapidly occurs and position deformation easily takes place, such problems are intended to be solved in such a manner that a resin composition is imparted with photocuring and thermal curing properties, so that it is temporarily attached using light irradiation and then thoroughly cured using thermal curing, thereby improving heat resistance or adhesiveness.

For example, a camera module, which is mounted in a camera or a camera embedded in electric electronic devices or mobile phones, is a key part that is able to take mobile and still images. In a camera module which is being currently developed or produced, a housing and a printed circuit board are attached to each other using a photocurable or thermocurable adhesive. On the other hand, in the recent development of high-pixel products of 8M or more, the pixel size of an image sensor has a tendency to decrease and thus a tilt between the sensor and the lens is increasingly important. Thereby, a process of correcting the tilt between the image sensor and the lens is additionally performed, and the corrected tilt should be essentially maintained. In the tilt correction process, a rapid curing type of photocurable adhesive is used, but attempts are being made to use a hybrid adhesive in order to ensure light shielding properties. The pigment contained in such a hybrid adhesive is intended to ensure light shielding properties but may decrease light transmittance, undesirably deteriorating photocuring properties. Also, in the case of an adhesive in which both a photocurable material and a thermocurable material are distributed, monomers and oligomers or curing initiators in the individual curable materials may interfere with each other upon polymerization, undesirably deteriorating curing properties at respective curing steps.

Meanwhile, Patent Document 1 discloses an adhesive composition which enables photocuring and thermal curing, but the core and shell are composed of a thermoplastic polymer, making it impossible to improve light shielding and photocuring properties.

Patent Document 1: Korean Unexamined Patent Publication No. 2006-0103537

### SUMMARY OF THE INVENTION

Culminating in the present invention, intensive and thorough research resulted in the finding that when an adhesive composition for an optical device is configured such that pigment balls having a core-shell structure are uniformly dispersed in a hybrid adhesive, light shielding and photocuring properties may be improved.

Accordingly, a first aspect of the present invention is to provide an adhesive composition for an optical device, which may improve light shielding and photocuring properties.

A second aspect of the present invention is to provide a method of adhering an optical device using the adhesive composition as above.

In order to accomplish the above first aspect, the present invention provides an adhesive composition for an optical device (hereinafter, referred to as “the first invention”), comprising pigment balls having a core-shell structure; a thermocurable monomer or oligomer; a photocurable monomer or oligomer; a photoinitiator; and a thermal initiator.

In the first invention, the adhesive composition may comprise 0.01˜5 wt % of the pigment balls, 30˜70 wt % of the thermocurable monomer or oligomer, 20˜60 wt % of the photocurable monomer or oligomer, 0.1˜10 wt % of the photoinitiator and 0.1˜10 wt % of the thermal initiator.

In the first invention, the pigment balls may be configured to have a core comprising a pigment and a shell comprising a thermocurable monomer or oligomer, a core comprising a thermocurable monomer or oligomer and a shell comprising a pigment, or a mixture thereof.

In the first invention, the pigment balls may comprise 5˜95 wt % of a pigment and 5˜95 wt % of a thermocurable monomer or oligomer.

In the first invention, the pigment balls may have an average particle size of 0.5˜5 μm.

In the first invention, the pigment may be a carbon- or metal-based pigment comprising one or more selected from the group consisting of carbon (C), titanium (Ti), copper (Cu), iron (Fe), manganese (Mn), silver (Ag), cobalt (Co) and chromium (Cr).

In the first invention, the thermocurable monomer or oligomer may include one or more selected from the group consisting of melamine, a uric acid monomer, bisphenol-A, xylenol, phenol, cresol, alkylphenol and an ethylenically unsaturated monomer having an epoxy group.

In the first invention, the photocurable monomer or oligomer may include one or more selected from the group consisting of fumaric acid, maleic acid, maleic anhydride, epoxy acrylate, urethane acrylate, polyester acrylate, a diazonium salt, a diaryliodonium salt and a triarylsulfonium salt.

In the first invention, the photoinitiator may include one or more selected from the group consisting of benzophenone, acetophenone, thioxanthone, an onium salt and a Bronsted-Lewis acid.

In the first invention, the thermal initiator may include one or more selected from the group consisting of carboxylic acid, benzoyl peroxide, azobenzene and azobisisobutyronitrile (AIBN).

In order to accomplish the above second aspect, the present invention provides a method of adhering an optical device (hereinafter, referred to as “the second invention”), comprising applying the adhesive composition according to the first invention on a substrate having an image sensor attached thereto; adhering a housing having a lens barrel to the adhesive composition; photocuring the adhesive composition; and thermally curing the adhesive composition.

In the second invention, photocuring may be performed in a wavelength range of 340˜380 nm.

In the second invention, thermally curing may be performed at 50˜200° C.

In the second invention, the optical device may be an imaging device or an image projection device.

### BRIEF DESCRIPTION OF THE DRAWINGS

The above and other objects, features and advantages of the present invention will be more clearly understood from the following detailed description taken in conjunction with the accompanying drawings, in which:

FIGS. 1A, 1B and 1C are cross-sectional views illustrating a core-shell structure comprising a pigment and a thermocurable monomer or oligomer, according to embodiments of the present invention;

FIGS. 2A and 2B are cross-sectional views illustrating an optical device when the adhesive composition according to the present invention is applied and an optical device when the adhesive composition according to the present invention is not applied, respectively;

FIG. 3 is of a cross-sectional view and a top plan view illustrating an adhesive portion of an optical device according to the present invention; and

FIG. 4 is a flowchart illustrating a process of adhering an optical device according to the present invention.

### DESCRIPTION OF SPECIFIC EMBODIMENTS

Before the present invention is described in more detail, it must be noted that the terms and words used in the present specification and claims should not be interpreted as being limited to typical meanings or dictionary definitions, but should be interpreted as having meanings and concepts relevant to the technical scope of the present invention based on the rule according to which an inventor can appropriately define a concept implied by a term to best describe the method he or she knows for carrying out the invention. Further, the embodiments of the present invention are merely illustrative, and are not to be construed to limit the scope of the present invention, and thus there may be a variety of equivalents and modifications able to substitute for them at the point of time of the present application.

In the following description, it is to be noted that embodiments of the present invention are described in detail so that the present invention may be easily performed by those skilled in the art, and also that, when known techniques related to the present invention may make the gist of the present invention unclear, a detailed description thereof will be omitted.

According to an embodiment of the present invention, an adhesive composition for an optical device includes pigment balls having a core-shell structure, a thermocurable monomer or oligomer, a photocurable monomer or oligomer, a photoinitiator and a thermal initiator, in order to improve light shielding and photocuring properties of an adhesive portion on which the above adhesive is applied.

Pigment Balls

In the present invention, the pigment balls are configured to have a core comprising a pigment and a shell comprising a thermocurable monomer or oligomer, or to have a core comprising a thermocurable monomer or oligomer and a shell comprising a pigment.

Each pigment ball includes 5˜95 wt % of a pigment and 5˜95 wt % of a thermocurable monomer or oligomer. Even when the core comprises either a pigment or a thermocurable monomer or oligomer, the amount of the core is set to 70 wt % or more, preferably 80 wt % or more, and more preferably 90 wt % or more, in terms of achieving effects of the present invention.

According to the present invention, the thermocurable monomer or oligomer includes one or more selected from the group consisting of melamine having an amino group, a uric acid monomer, phenols such as bisphenol-A, xylenol, phenol, cresol and alkylphenol, and an ethylenically unsaturated monomer having an epoxy group.

The pigment may be a carbon- or metal-based pigment comprising one or more selected from the group consisting of carbon (C), titanium (Ti), copper (Cu), iron (Fe), manganese (Mn), silver (Ag), cobalt (Co) and chromium (Cr).

In the adhesive composition according to the present invention, the pigment balls are used in an amount of 0.01˜5 wt %, and preferably 0.01˜1 wt %. If the amount of the pigment balls is less than 0.01 wt %, light shielding properties of the adhesive composition may deteriorate, and thus light transmittance may increase. In contrast, if the amount thereof exceeds 5 wt %, the degree of curing of the inside of the adhesive composition may decrease, undesirably deteriorating photocuring properties.

Also, the average particle size of the pigment balls is 0.5˜5 μm, preferably 1˜3 μm, and more preferably about 1 μm. If the average particle size of the pigment balls is less than 0.5 μm, the adhesive composition according to the present invention cannot function to appropriately shield light upon photocuring. Hence, when the amount of the pigment balls is increased, the pigment balls distributed in a larger amount in the adhesive composition may increase a light shielding effect from the surface of the composition, undesirably deteriorating curing properties of the inside thereof. In contrast, if the average particle size of the pigment balls exceeds 5 μm, dispersibility of the adhesive may decrease, and thus the pigment balls may not be uniformly distributed in the composition. Thus, upon photocuring, almost all of the pigment balls may shield light, whereby light does not reach the photoinitiator which is present at the inside of the adhesive composition, so that photocuring does not properly occur.

A conventional hybrid adhesive is first photocured and then thermally cured. However, because the pigment contained in the hybrid adhesive is provided in the form of a colloid, the amount of the pigment in the adhesive composition should be increased to ensure light shielding properties. Ultimately, light does not reach the photoinitiator at the inside of the hybrid adhesive, so that photocuring cannot properly occur. Hence, in the adhesive composition according to the present invention, the pigment having a micrometer (μm) particle size is added in an amount lower than that of the pigment of the conventional hybrid adhesive, and simultaneously enables light to reach the photoinitiator, thereby improving both light shielding and photocuring properties.

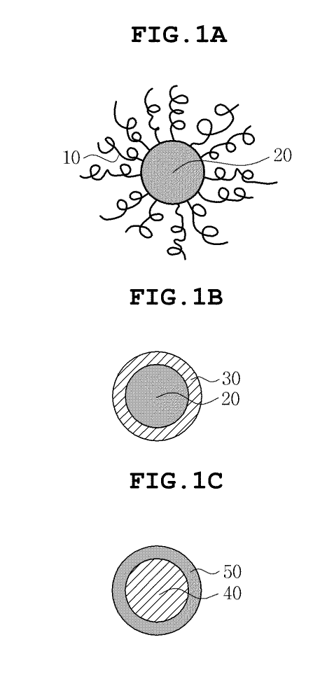

FIG. 1A illustrates a core composed of a pigment 20 and a thermocurable monomer or oligomer 10 adsorbed to the outer surface of the core, FIG. 1B illustrates a pigment ball configured to have a core composed of a pigment 20 and a shell 30 composed of a thermocurable monomer or oligomer, and FIG. 1C illustrates a pigment ball configured to have a core 40 composed of a thermocurable monomer or oligomer pigment and a shell 50 composed of a pigment. The core-shell structure illustrated in FIG. 1B is manufactured in such a manner that a pigment is synthesized or separately prepared in the form of a micrometer (μm) particle size, thus forming a core, which is then dispersed in a solvent in which a thermocurable monomer or oligomer having a functional group which may be coupled with the core is dissolved, so that the core is coated. In contrast, the pigment ball illustrated in FIG. 1C is manufactured in such a manner that a thermocurable monomer or oligomer is prepared to have a micrometer (μm) particle size, thus forming a core, which is then dispersed in an amine-based metal reducible solvent, after which a metal oxide is slowly added to the dispersed solution, and a reduction reaction is carried out at a temperature lower than about 200° C., thereby coating the core with the pigment film.

In the adhesive composition according to the present invention, the core-shell structures illustrated in FIGS. 1B and 1C may be used alone or in combination. Further, the shape of the structure illustrated in FIG. 1A wherein the thermocurable monomer or oligomer is adsorbed on the outer surface of the core composed of the pigment may be regarded as the same as that of the structure illustrated in FIG. 1B.

Thermocurable Monomer or Oligomer

According to the present invention, the thermocurable monomer or oligomer includes one or more selected from the group consisting of melamine having an amino group, a uric acid monomer, phenols such as bisphenol-A, xylenol, phenol, cresol and alkylphenol, and an ethylenically unsaturated monomer having an epoxy group. Also, the ethylenically unsaturated monomer is not particularly limited, but is either one of ethylene glycol diacrylate and ethylene glycol dimethacrylate.

The thermocurable monomer or oligomer may be the same as or different from the thermocurable monomer or oligomer used in the pigment balls, in terms of adhesiveness of a final composition.

The amount of the thermocurable monomer or oligomer is not particularly limited, and may be set to 30˜70 wt %. If the amount of the thermocurable monomer or oligomer is less than 30 wt %, thermal curing time of the adhesive composition may increase, or adhesiveness may decrease. In contrast, if the amount thereof exceeds 70 wt %, polymerization of the photocurable material may be obstructed upon photocuring.

Photocurable Monomer or Oligomer

According to the present invention, the photocurable monomer or oligomer includes one or more selected from the group consisting of dibasic acids or dihydric alcohols such as fumaric acid, maleic acid and maleic anhydride, acrylates such as epoxy acrylate, urethane acrylate and polyester acrylate, and cation polymerizable monomers such as a diazonium salt, a diaryliodonium salt and a triarylsulfonium salt.

The amount of the photocurable monomer or oligomer is not particularly limited, and may be set to 20˜60 wt %. If the amount of the photocurable monomer or oligomer is less than 20 wt %, photocuring time of the adhesive composition may increase, or adhesiveness may decrease. In contrast, if the amount thereof exceeds 60 wt %, polymerization of the thermocurable material may be obstructed upon thermal curing.

Photoinitiator According to the present invention, the photoinitiator includes one or more selected from the group consisting of benzophenone, acetophenone, thioxanthone, an onium salt and a Bronsted-Lewis acid.

The amount of the photoinitiator is not particularly limited, and may be set to 0.1˜10 wt %. If the amount of the photoinitiator is less than 0.1 wt %, a photocuring rate may decrease considerably, and hardness may decrease. In contrast, if the amount thereof exceeds 10 wt %, the degree of curing of the inside of the adhesive composition may decrease.

Thermal Initiator

According to the present invention, the thermal initiator includes one or more selected from the group consisting of carboxylic acid, benzoyl peroxide, azobenzene and azobisisobutyronitrile (AIBN).

The amount of the thermal initiator is not particularly limited, and may be set to 0.1˜10 wt %. If the amount of the thermal initiator is less than 0.1 wt %, a thermal curing rate may remarkably decrease. In contrast, if the amount thereof exceeds 10 wt %, polymerization of the photocurable material may be obstructed upon photocuring.

In addition, according to an another embodiment of the present invention, a method of adhering an optical device using the above adhesive composition comprises applying the above adhesive composition on a substrate having an image sensor attached thereto; adhering a housing having a lens barrel to the adhesive composition; photocuring the adhesive composition; and thermally curing the adhesive composition.

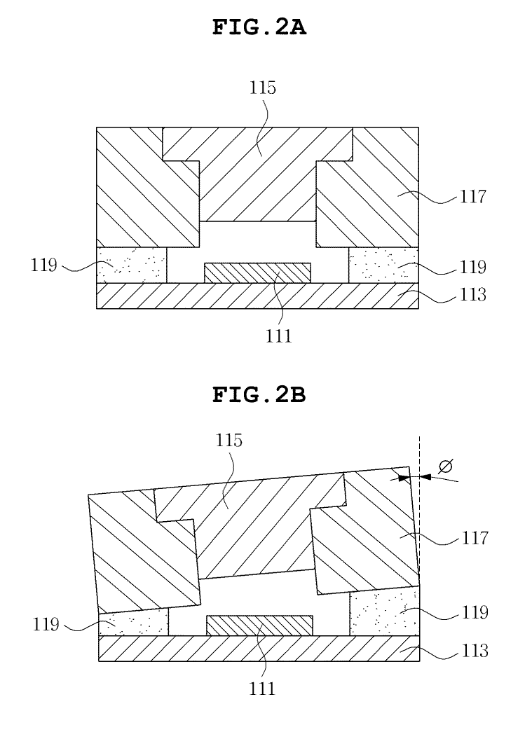

FIGS. 2A and 2B are cross-sectional views illustrating an optical device when the adhesive composition according to the present invention is applied and an optical device when the adhesive composition according to the present invention is not applied, respectively.

FIG. 2A illustrates the optical device which is configured such that a substrate 113 for typical use in an optical device, having an image sensor 111 attached thereto, and a housing 117 having a lens barrel 115, are adhered to each other using the adhesive composition according to the present invention. The adhesive applied along the edge of the substrate 113 is composed of the adhesive composition according to the present invention, and light shielding and photocuring properties of the optical device may be improved thanks to the above adhesive. In the optical device to which the adhesive according to the present invention having superior light shielding and photocuring properties is applied, the tilt is adjusted to attune the angle of the lens of the housing and the image sensor so that the housing is positioned and then fixedly attached via photocuring. Thus, upon attaching the substrate and the housing of the optical device by virtue of the adhesive according to the present invention having superior photocuring properties, there is little or no position deformation, thereby minimizing correction of the tilt. Furthermore, light shielding properties may be ensured by the use of the adhesive according to the present invention, so that there is no interference of light which enters the optical device.

However, the optical device illustrated in FIG. 2B is configured such that a substrate 113 for typical use in an optical device, having an image sensor 111 attached thereto, and a housing 117 having a lens barrel 115, are adhered to each other using a conventional hybrid adhesive composition. As the pigment of the hybrid adhesive applied along the edge of the substrate 113 is provided in the form of a colloid, the pigment should be contained in a larger amount in the adhesive composition. Consequently, light does not reach the photoinitiator, and thus photocuring does not properly occur and photocuring properties deteriorate. Accordingly, upon adhering the substrate 113 and the housing 117, in the course of thermal curing being carried out in a state of photocuring not properly occurring, the substrate and the housing may be unbalanced, and the image sensor 111 and the lens may also be unbalanced. Thus, the substrate and the housing are not horizontally maintained and are unbalanced at opposite sides thereof, and the vertical tilting angle represented by “Φ” in FIG. 2B is formed.

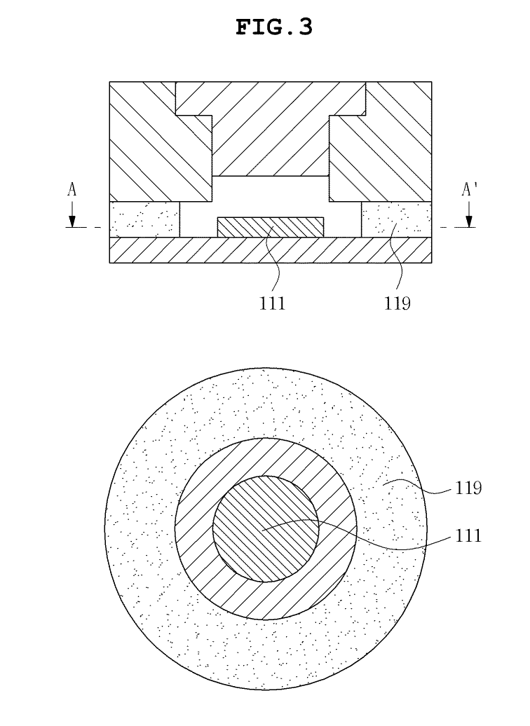

FIG. 3 illustrates a cross-sectional view and a top plan view of the adhesive portion of the optical device according to the present invention. The adhesive portion 119 is formed on the edge of the substrate 113 having the image sensor 111 of the optical device, thereby improving light shielding properties for shielding light that enters the device by virtue of the adhesive according to the present invention and photocuring properties of the above adhesive.

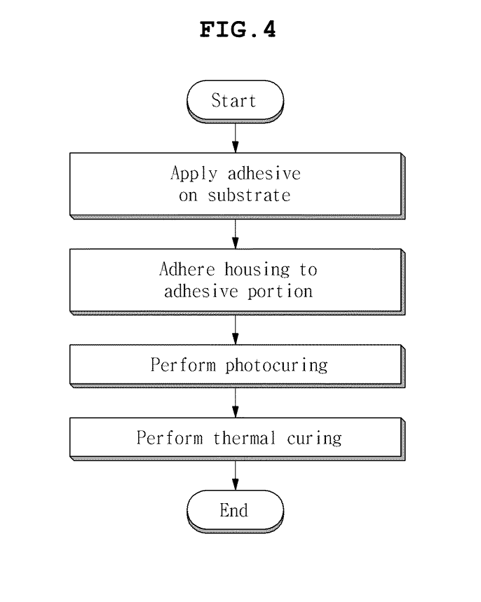

FIG. 4 is a flowchart sequentially illustrating a process of adhering the optical device according to the present invention.

In the present invention, photocuring is performed in the wavelength range of 340˜380 nm, and preferably 350˜365 nm. If the wavelength is less than 340 nm, photocuring time may increase, undesirably causing balance problems upon adhering the optical device. In contrast, if the wavelength exceeds 380 nm, properties of the photocurable material may deteriorate.

In the present invention, thermal curing is carried out in the temperature range of 50˜200° C., and preferably 120˜160° C. If the temperature is lower than 50° C., thermal curing time may increase, undesirably causing balance problems upon adhering the optical device. In contrast, if the temperature is higher than 200° C., properties of the thermocurable material may deteriorate.

Also, the optical device according to the present invention includes, for example, an imaging device such as a lens shutter camera, a digital still camera, a video camera, etc., or an image projection device such as a projector, etc., but the present invention is not limited thereto.

Better understanding of the present invention may be obtained via the following examples and comparative example which are set forth to illustrate, but are not to be construed as limiting, the present invention.

### Example 1

2 g of a titanium (Ti) pigment having an average particle size of about 1 μm was dispersed in 100 g of a glycol monobutyl ether acetate solvent in which 10 g of ethylene glycol diacrylate was dissolved, and coated, thus manufacturing pigment balls having a core-shell structure. 2 g of the pigment balls having a core-shell structure, 207.5 g of epoxy acrylate, 15 g of azobisisobutyronitrile (AIBN) and 20 g of benzophenone were mixed, thus preparing an adhesive composition.

### Example 2

An adhesive composition was prepared under the same conditions as in Example 1, with the exception that a Ti pigment having an average particle size of about 3 turn was used.

### Example 3

An adhesive composition was prepared under the same conditions as in Example 1, with the exception that a silver (Ag) pigment having an average particle size of about 1 μm was used.

### Example 4

An adhesive composition was prepared under the same conditions as in Example 1, with the exception that an Ag pigment having an average particle size of about 5 μm was used.

### Example 5

A solution of 4 g of epoxy polymer particles having an average particle size of about 5 μm dispersed in 1 L of distilled water was added with 200 mg of silver nitrate (AgNO₃) and 37 mg of a metal reducible reductant, that is, sodium borohydride. The surfaces of the epoxy polymer particles were coated with silver (Ag), thus manufacturing pigment balls having a core-shell structure. 4 g of the pigment balls having a core-shell structure, 200 g of alkylphenol, 207.5 g of epoxy acrylate, 30 g of AIBN and 40 g of benzophenone were mixed, thus preparing an adhesive composition.

### Example 6

An adhesive composition was prepared under the same conditions as in Example 5, with the exception that an epoxy polymer having an average particle size of about 1 μm was used.

### Comparative Example 1

4 g of a Ti pigment having an average particle size of about 50 nm, 200 g of alkylphenol, 207.5 g of epoxy acrylate, 30 g of AIBN and 40 g of benzophenone were mixed, thus preparing an adhesive composition.

Evaluation of Photocuring Properties

On a substrate 113 illustrated in FIG. 2A, the adhesive composition of each of the examples and comparative example was applied to a thickness of 100 μm, after which a light shielding film was formed to prevent incidence of light in a vertical direction. The degree of photocuring was measured at the side of the applied adhesive composition under conditions of a UV wavelength of 365 nm for 3 sec, using a Photo calorimeter DSC (TA, USA), and a period of time required to terminate the photocuring was measured. Also, light shielding properties were evaluated by measuring the inside of the substrate 113 at a point of time at which the photocuring was terminated, using a UV-Vis Spectrometer (PerkinElmer).

TABLE 1

| | Photocuring | Photocuring | |
|---|---|---|---|
| | (%) | time (sec) | Light shielding (%) |
| Ex. 1 | 99 | 5 | 95 |
| Ex. 2 | 96 | 7 | 90 |
| Ex. 3 | 99 | 5 | 94 |
| Ex. 4 | 88 | 8 | 89 |
| Ex. 5 | 87 | 8 | 90 |
| Ex. 6 | 97 | 5 | 94 |
| Comp. Ex. 1 | 48 | 20 | 90 |

As is apparent from Table 1, the examples using the adhesive composition according to the present invention were improved in the degree of photocuring and light shielding properties and exhibited the shorter photocuring time, compared to the comparative example using the conventional hybrid adhesive composition.

In Examples 1 and 3, there was no difference in results when using different pigment materials, and in Examples 1, 2 and 4, different results were obtained depending on a difference in the size of the pigment. In Examples 5 and 6, different results were obtained depending on a difference in the size of the pigment balls. Accordingly, the size of the pigment balls can be seen to affect the results.

As described hereinbefore, the present invention provides an adhesive composition for an optical device and an adhering method using the same. According to the present invention, the adhesive composition can contain pigment balls having a core-shell structure, thus improving both light shielding and photocuring properties.

Although the embodiments of the present invention have been disclosed for illustrative purposes, those skilled in the art will appreciate that a variety of different modifications, additions, and substitutions are possible, without departing from the scope and spirit of the invention as disclosed in the accompanying claims.

Accordingly, such modifications, additions, and substitutions should also be understood as falling within the scope of the present invention.

What is claimed is:

1. An adhesive composition for an optical device, comprising:
pigment balls having a core-shell structure;
a thermocurable monomer or oligomer;
a photocurable monomer or oligomer;
a photoinitiator; and
a thermal initiator.

2. The adhesive composition of claim 1, comprising 0.01˜5 wt % of the pigment balls, 30˜70 wt % of the thermocurable monomer or oligomer, 20˜60 wt % of the photocurable monomer or oligomer, 0.1˜10 wt % of the photoinitiator and 0.1˜10 wt % of the thermal initiator.

3. The adhesive composition of claim 1, wherein the pigment balls are configured to have a core comprising a pigment and a shell comprising a thermocurable monomer or oligomer, a core comprising a thermocurable monomer or oligomer and a shell comprising a pigment, or a mixture thereof.

4. The adhesive composition of claim 1, wherein the pigment balls comprise 5˜95 wt % of a pigment and 5˜95 wt % of a thermocurable monomer or oligomer.

5. The adhesive composition of claim 1, wherein the pigment balls have an average particle size of 0.5˜5 μm.

6. The adhesive composition of claim 2, wherein the pigment is a carbon- or metal-based pigment comprising one or more selected from the group consisting of carbon (C), titanium (Ti), copper (Cu), iron (Fe), manganese (Mn), silver (Ag), cobalt (Co) and chromium (Cr).

7. The adhesive composition of claim 1, wherein the thermocurable monomer or oligomer includes one or more selected from the group consisting of melamine, a uric acid monomer, bisphenol-A, xylenol, phenol, cresol, alkylphenol and an ethylenically unsaturated monomer having an epoxy group.

8. The adhesive composition of claim 2, wherein the thermocurable monomer or oligomer includes one or more selected from the group consisting of melamine, a uric acid monomer, bisphenol-A, xylenol, phenol, cresol, alkylphenol and an ethylenically unsaturated monomer having an epoxy group.

9. The adhesive composition of claim 1, wherein the photocurable monomer or oligomer includes one or more selected from the group consisting of fumaric acid, maleic acid, maleic anhydride, epoxy acrylate, urethane acrylate, polyester acrylate, a diazonium salt, a diaryliodonium salt and a triarylsulfonium salt.

10. The adhesive composition of claim 1, wherein the photoinitiator includes one or more selected from the group consisting of benzophenone, acetophenone, thioxanthone, an onium salt and a Bronsted-Lewis acid.

11. The adhesive composition of claim 1, wherein the thermal initiator includes one or more selected from the group consisting of carboxylic acid, benzoyl peroxide, azobenzene, and azobisisobutyronitrile (AIBN).

12. A method of adhering an optical device, comprising:
applying the adhesive composition of claim 1 on a substrate having an image sensor attached thereto;
adhering a housing having a lens barrel to the adhesive composition;
photocuring the adhesive composition; and
thermally curing the adhesive composition.

13. The method of claim 12, wherein the photocuring is performed in a wavelength range of 340˜380 nm.

14. The method of claim 12, wherein the thermally curing is performed at 50˜200° C.

15. The method of claim 12, wherein the optical device is an imaging device or an image projection device.
